(19) United States
(12) Patent Application Publication
(10) Pub. No.: US 2009/0299883 A1
(43) Pub. Date: Dec. 3, 2009

(54) Graduation function for stored value card

(75) Inventors: David Ross Baumgartner, IV, Parker, CO (US); Virgil McDowell Mathias, JR., Parker, CO (US)

Correspondence Address: Visa USA c/o Duane Morris LLP;Attn: James Sze, Esq., 101 West Broadway, Suite 900, San Diego, CA, 92101, US

(73) Assignee: Visa U.S.A. Inc.

(21) Appl. No.: 12/455,077

(22) Filed: May 28, 2009

Related U.S. Application Data
(60) Provisional application No. 61/130,469, filed on May 30, 2008.

(51) Int. Cl. G06Q 40/00; G06Q 10/00; G06Q 20/00; G06K 19/06

(52) U.S. Cl. 705/30; 705/35; 705/41; 705/44; 705/45; 235/493

(57) ABSTRACT

A stored value card and system provides a stored value card issued in the name of a cardholder and with an account associated with an issuer and a legal account holder. The legal account holder is initially a person or entity other than the cardholder. The legal account holder manages the account and is authorized to add funds to the account and the cardholder is authorized to use the funds in the account. As the account is being used, and account data is changing, the account data is compared to a plurality of triggering criteria. When a predetermined number of the triggering criteria are satisfied, the nature of the account is changed and the cardholder becomes the legal account holder who then manages and owns the funds in the account.

### RELATED APPLICATION

This application claims priority of U.S. Provisional Patent Application No. 61/130,469 entitled Graduation Function for Stored Value Card, filed May 30, 2008, the contents of which are hereby incorporated by reference, as if set forth in their entirety.

### FIELD OF THE INVENTION

Aspects of the present invention relates to stored value cards and methods and systems for issuing the same, and more particularly to stored value cards in which the legal account holder is changed when certain triggering criteria are satisfied.

### BACKGROUND

Stored value or pre-paid cards have become very popular due to the convenience that they provide. Such stored value cards are universally accepted in the physical and virtual world where cash is not an option. Stored value cards find acceptability at merchant locations, at ATMs, and for orders placed and payments made over the internet and over the telephone. Such stored value cards are generally welcome everywhere that debit cards or credit cards are welcome.

Stored value cards may be issued in the name of a cardholder with the financially responsible legal account holder being another person. The cardholder's name is that which appears on the face of the stored value card. In one example, a parent may be a legal account holder for a stored value card issued in the name of a cardholder being a teen. When such stored value cards are provided by a parent to a teenager, they help develop responsible financial behavior in a parent-supervised environment. Stored value cards offer an easy way for parents to give and for teens to receive spending money and provide a simpler way to keep track of money as opposed to carrying cash. Transactions may be reviewed electronically. The stored value cards are safer than cash because lost or stolen stored value cards may be replaced with full remaining value. By having and using such a stored value card, loyalty is built between the cardholder and various merchants as well as between the card issuer and the cardholder and legal account holder. The cards increase a cardholder's sense of maturity and independence and eliminate trips to the bank and the awkwardness of requesting cash from the legal account holder. This is especially true when the legal account holder is a parent and the cardholder a teen or other dependent.

Stored value cards also benefit merchants by way of increased sales. Moreover, card issuers gain access to a new market such as the teen cardholder market. Such stored value cards thus continue to grow in popularity.

One shortcoming associated with available stored value cards and systems that issue the same, is the lack of a method or system for a cardholder who is not the legal account holder, to become the legal account holder without opening up a new account, i.e. there is no known system for a cardholder's status to change from being a cardholder/non-legal account holder to both the cardholder and the legal account holder. In other words, conventional stored value cards and systems for issuing the same do not provide for a teen cardholder having a parent-controlled account, for example, to have the account switched to being an account that is self-managed by the teen cardholder. Existing systems and methods require a new account, i.e. an account with no previous history, to be created. The inconvenience of having to create a new account represents a shortcoming associated with available stored value cards and systems that issue the same, as this diminishes retention of cardholders who are likely to consider other issuers if a new account must be created. As a result, many cardholders will switch financial institutions and card issuing entities.

### SUMMARY OF THE INVENTION

Embodiments of the invention include a method of transferring legal account ownership for a stored value card. The method includes issuing a stored value card in the name of a first person authorized to use the stored value card, and associated with an account and a legal account holder including an initial legal account holder being a second person. The method compares account data to each of a plurality of triggering criteria and, when a predetermined number of the plurality of triggering criteria is satisfied by the account data, transferring the legal account holder from the second person to the first person. The method may further include notifying the first person, the second person, or both, of the transfer.

According to another aspect, a system embodiment issues a stored value card affiliated with an issuer, a cardholder and a legal account holder. A financial processing system creates one account associated with a stored value card and a card generating system issues the stored value card in the name of a cardholder authorized to use the stored value card and associated with a legal account holder. The initial legal account holder is different than the cardholder and the issued stored value card is marked with the cardholder's name. A financial transaction processing system further compares account data of the stored value card to each of a plurality of triggering criteria and determines when a predetermined number of the triggering criteria is satisfied by the account data. The system further provides for transferring the legal account holder from the initial legal account holder to the cardholder if the predetermined number of the plurality of triggering criteria is satisfied by the account data.

The stored value card account is maintained as the cardholder graduates from having the account managed by an initial legal account holder being different than the cardholder, to the cardholder him or herself becoming the legal account holder.

### BRIEF DESCRIPTION OF THE DRAWING

The embodiments of the present invention are best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is a schematic flow diagram showing aspects of cardholder enrollment;

FIG. 2 is a schematic flow chart showing the graduation of the cardholder from being simply the cardholder to being the cardholder and legal account holder; and

FIG. 3 is a schematic diagram of an exemplary system for issuing a stored value card and changing the legal account holder upon graduation.

### DETAILED DESCRIPTION

Aspects of the invention include an issuer issuing a stored value card in the name of a cardholder. A single stored value card account may be opened and is associated with the cardholder, a legal account holder and an issuer. The legal account holder is bound by the terms and conditions of the card agreement, owns the funds and manages all aspects of the account. The cardholder is exclusively authorized to use the card. The initial legal account holder may be different than the cardholder and one aspect of the invention is the transformation of the account, through which process the cardholder becomes the legal account holder.

According to one exemplary embodiment, the cardholder may be a teen or other dependant with the legal account holder being the guardian of the teen or dependent cardholder. According to one exemplary embodiment, the cardholder may be a teen with the teen's parent being the legal account holder.

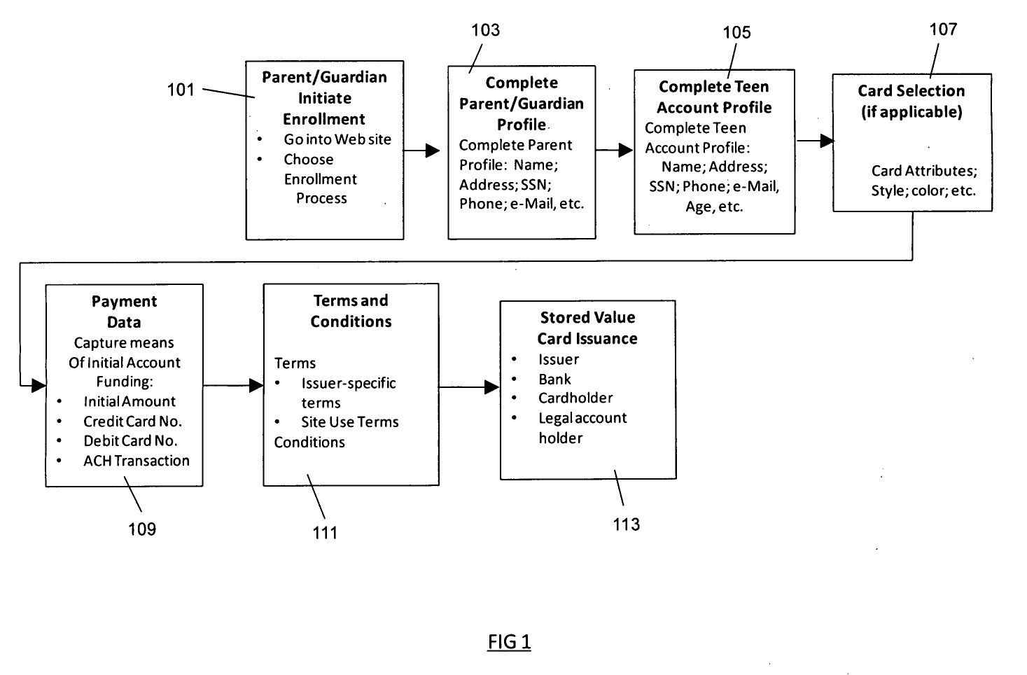

Conventional methods for opening up an account for a stored value card may be used. The account is opened and managed by a financial processing computer system or network that settles transactions and adds funds and so forth, as available in the financial products industry. Although the following examples often refer to the cardholder being a teen and the legal account holder being a parent or parent/guardian such as in FIG. 1, it should be understood that such is exemplary only. According to various exemplary embodiments, the cardholder and initial legal account holder may be any two different persons or entities. FIG. 1 is a schematic flow diagram showing an exemplary sequence of operations in cardholder enrollment. At block 101, enrollment is initiated by the legal account holder and may be carried out at least partially through a website of the issuer. At block 103, the parent/guardian profile is completed and includes relevant information such as contact information such as address, phone number, e-mail address and so forth and other identifying information such as social security number. These are intended to be exemplary only. At block 105, the teen account profile is completed with similar contact and identifying information. At optional block 107, card selection is carried out. The card size, style, color and so forth may optionally be selected at block 107.

Payment data may be supplied at block 109. Initial funding of the card may be done at block 109 by the parent/guardian or teen in one embodiment and initial funding may be done only by the parent/guardian in another embodiment. Payment data may include an initial amount, and an identification of the credit and debit cards that may be used in the future to fund the stored value card and it may involve an ACH (Automated Clearing House) transaction for initial funding. Terms and conditions of card usage are provided at block 111. The legal account holder, i.e. the parent/guardian, is the entity who is bound by and who must agree to, the terms and conditions. In one exemplary embodiment, the parent/guardian is exclusively bound by the terms and conditions. The issuer and/or legal account holder may specify minimum and maximum amounts on the card and other aspects and parameters of the stored value card and its usage. At block 113, the card is issued. The method illustrated in the flow diagram of FIG. 1 is intended to be exemplary only and other sequences may be used to open up an account and establish a stored value card according to the invention. As initially set up, the account is associated with an issuer, a bank or other financial institution or merchant, and includes the cardholder, whose name appears on the card, and an initial legal account holder being different than the cardholder. A suitable conventional card generating system may be used to generate the stored value card and mark the stored value card with the cardholder's name.

In one exemplary embodiment, the stored value card provided to the cardholder may be a magnetic-stripe, embossed card displaying identifying indicia such as the issuer and the associated financial institution. In other exemplary embodiments, the stored value card may be a virtual card, a contactless card or a chip card. The stored value card may include a PIN, personal identification number, to permit cash withdrawals at ATMs and other point-of-sale locations. The stored value card will generally include an expiration date as well as the account number and may include a medium such as the magnetic-stripe that stores information associated with the account.

Once established, the legal account holder manages the account and owns the funds. The account allows the legal account holder to reactivate the account, close the account, resolve disputes, suspend the account, have access to electrically monitor the account and select a personal identification number. The legal account holder may be exclusively authorized to load funds onto the account and identify a further giver or givers designated to add funds to the account. Funds may be added to the card from another credit card account, an off-line debit card or check card account, an intrabank transfer, paper checks, and cash. The legal account holder may set cash access limits and will receive notifications of spending habits.

The teen cardholder is set up as the authorized user of the stored value card account and can use the card to make purchases, make ATM withdrawals, make payments, make interlink purchases with cash back through all suitable channels such as point-of-sale physical transactions, PIN-based purchases, transactions over the internet and transactions over the telephone. The stored value card may be used as a typical debit/credit product. The teen cardholder authorized user is also authorized to choose a personal identification number, check balances, receive account statements, resolve disputes, suspend use of the card and dispute a transaction but the teen cardholder does not own the funds in the account. In one exemplary embodiment, the legal account holder may establish further terms, conditions and parameters regarding the cardholder's use of the stored value card. For example, the legal account holder may restrict the frequency of use of the card, the types of transactions for which the card is used, the amount of cash back to the authorized user cardholder, the total amount of spending, or the types of merchants at which the card may be used. These are intended to be exemplary only and in other exemplary embodiments, the legal account holder may establish other parameters for use of the card. Web access to the account may be available to enable both the legal account holder and cardholder to review the account transactions.

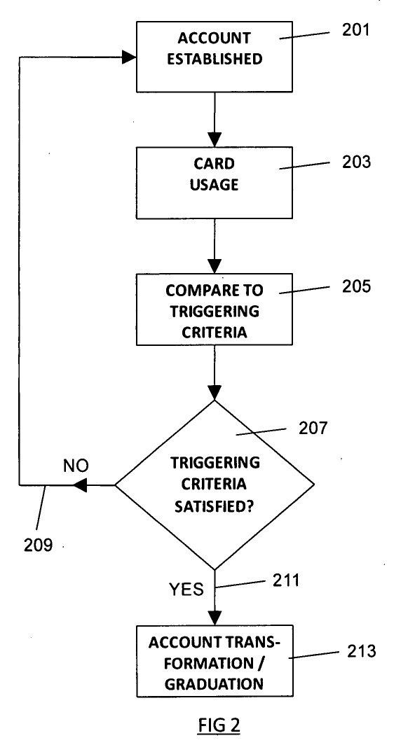

FIG. 2 is a schematic flow diagram showing the graduation process by which the cardholder, who is not the initial legal account holder, becomes the legal account holder. This graduation process may take place automatically by the system or it may be effectuated manually by the initial legal account holder. In one exemplary embodiment, the original account may be maintained during the graduation process and in this manner, account history is maintained. In another exemplary embodiment, a new account may be established automatically, i.e. an account with no history. In any event, before the graduation process, the stored value card is associated with a cardholder and separate legal account holder and after the graduation process, the cardholder becomes the legal account holder who owns the funds and manages all aspects of the account such as adding funds.

Referring to FIG. 2, an account is established at block 201 as described supra. Conventional means may be used to create the account and the account is associated with an issuer or merchant, a financial institution or merchant, a cardholder and a legal account holder who owns the cards funds and manages the account. Initially, the initial legal account holder is a person or entity distinguished from the cardholder. The cardholder is the authorized user who can spend the funds in any of the aforementioned manners and view transaction history but who cannot load funds or manage the account. As above, other terms, conditions and parameters of the card's use may be established by the legal account holder as part of the managerial duties. The account may be established with and handled by a conventional financial system used for establishing, controlling, and monitoring such accounts.

Additionally, a number of triggering criteria are set up and associated with the account. The triggering criteria may be conventional triggering criteria suggested by the issuer or they may be provided by the initial legal account holder. If a predetermined number of the triggering criteria are satisfied, the account is transformed from being an account in which the cardholder and legal account holder, i.e. the initial legal account holder, are two different people, to being an account in which the cardholder is the legal account holder. In other words, the cardholder graduates to becoming the legal account holder with all the managerial duties associated therewith when the triggering criteria is/are satisfied. The number of triggering criteria that must be satisfied in order for this event to occur may be pre-determined by the legal account holder and/or the financial institution, and input into the system. Examples of triggering criteria include the following:
Age of the cardholder. For example, this triggering criteria may be satisfied when the cardholder reaches a certain age such as 18 years old.
Age of the account. This triggering criteria may be satisfied when the account has been established for a certain period of time. In one exemplary embodiment, this triggering criteria may be satisfied when the account is two, three or four years old.
Number or value or transactions within a specified time. According to this triggering criteria, the criteria may be satisfied if a predetermined amount of annual spending has been made. In another exemplary embodiment, this triggering criteria may be satisfied if a prescribed amount of monthly spending has been made for a prescribed number of months.
Date. According to this triggering criteria, the criteria is satisfied when a certain date is reached.
Total value loaded onto the card. According to this triggering criteria, the criteria may be satisfied if a predetermined total value has been loaded onto the card during a time period of predetermined length.
No negative balance. According to this triggering criteria, the criteria is satisfied when there is no negative balance on the card during a time period of predetermined length.
Account balance. According to this triggering criteria, the criteria is satisfied if a certain level of account balance has been maintained for a prescribed period.

The above list of triggering criteria is intended to be exemplary only and various other triggering criteria may be used. According to various exemplary embodiments, various other aspects of account usage may be monitored and the various triggering criteria may be satisfied by various triggering conditions.

At block 203, the stored value card is being used by the cardholder and the account data dynamically changes in time and as transactions are made. As the stored value card is used, the age of the account and the cardholder advance and as transactions adding value to the card and using the funds from the card are carried out, aspects of the account data such as total amount of transactions, the value of the transactions, the frequency of the transactions, the average account balance and the like, also change.

At block 205, account information and data is compared to the triggering criteria. This may be done automatically by a suitable financial transaction processing system within which the account is established. The system may be a conventional computer-based processing system used by financial institutions for managing credit card accounts and the like. In particular, the system may include a processor that processes conventional prepaid stored value cards and according to one embodiment, the processor may be a central processing unit (CPU) of a computer. According to various exemplary embodiments, the financial transaction processing system for processing the stored value card may include a processing module, a database module, inputs and outputs and a transaction module, but such is exemplary only. According to one exemplary embodiment, the database module may include an account database, a balance database, a transaction database and other databases. The account database may be responsible for storing information regarding parameters related to use of the account such as terms and conditions and other information and account usage parameters that may be established when the account was set up. The account database may also contain data such as the triggering criteria. The balance database module may be responsible for storing information about the account balance. The transaction database may store information related to each stored value card transaction including the addition of funds to the account and every use associated with the account. It should be understood that the described system is exemplary only and other suitable systems capable of comparing account balance, transaction and usage data to the triggering criteria may be used.

Still referring to block 205, the comparing may be done on a regular basis or essentially constantly, according to various exemplary embodiments. The financial transaction processing system compares information regarding account balance, usage and transactions, to the triggering criteria according to various exemplary embodiments. The system may accumulate buckets of information in the transaction database and/or the balance database that are compared to the triggering criteria and the bucket may be accumulated over various regular or irregular time intervals. For example the comparison may be done hourly, daily, weekly, monthly or over any suitable time period.

At block 207, it is determined whether the predetermined number of triggering criteria are satisfied. If no, 209, the established account remains unchanged. If yes, 211, the account transformation or graduation process takes place at block 213. At block 213, the legal account holder is switched from being the initial legal account holder to being the cardholder. Stated alternatively, the cardholder becomes the legal account holder. The transfer may be done automatically by the above-described financial transaction processing system in one exemplary embodiment. Other computer based or other suitable financial processing systems may be used as an account transfer system to carry out the transfer automatically in other exemplary embodiments. According to a first embodiment, the same system that performs the comparison to the triggering criteria, as in step 205, may be used to effectuate the transfer and according to a second embodiment, a second suitable system may be used as the account transfer system. According to yet another embodiment, the account transformation may be manually authorized by the legal account holder who becomes dissociated from the account after the account transformation.

After the graduation process takes place, at block 213, the cardholder is the legal account holder who exclusively manages the account and owns the account. According to one exemplary embodiment, the single account that was opened to establish the stored value card is maintained. According to this exemplary embodiment, the card and card/account number advantageously remain the same and the account history is maintained. According to another exemplary embodiment, a new account is automatically generated by the system and according to this exemplary embodiment, a new card may be generated or the preexisting card may continue to be used and according to this exemplary embodiment, the card number may remain the same or it may be changed. Also at block 213, notification of the graduation may be automatically sent to the cardholder, initial account holder or both, via e-mail, mail, text messages or other suitable means of communication. According to one exemplary embodiment, after such notification, acceptance may optionally be required by the cardholder, initial account holder or both, in order to effectuate the change in account. Acceptance may be provided in various manners, and in one exemplary embodiment, continued use of the card after notification may constitute acceptance.

After the change that takes place at graduation, the initial legal account holder is no longer the legal account holder and is no longer associated with the account and the cardholder is no longer associated with the initial legal account holder but, rather, exclusively controls and manages the account.

According to various exemplary embodiments, further givers may be identified by the legal account holder. Only the legal account holder and designated further givers can add funds onto the card. The legal account holder retains the responsibility of designating a further giver or givers before and after the account is changed. In other words, the further giver is initially identified by the initial account holder who is not the cardholder and after the cardholder becomes the legal account holder the cardholder may now designate one or more further givers.

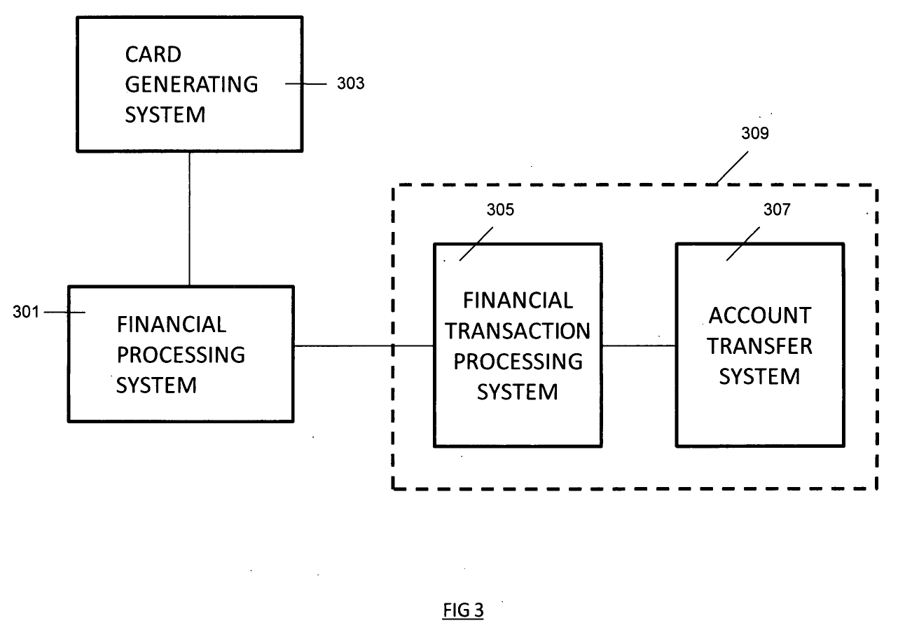

An exemplary system is shown schematically in FIG. 3. Financial processing system 301 opens the account as described supra. Card generating system 303 may be used to generate the stored value card and mark the stored value card with the cardholder's name and other indicia. Financial transaction processing system 305 compares account information and data to the triggering criteria as described supra. Account transfer system 307 effectuates the transfer of the account, i.e. the graduation process. In one embodiment, financial transaction processing system 305 and account transfer system 307 are separate systems but according to another embodiment, consolidated system 309 may carry out both the data accumulation and comparison to the triggering criteria as described in conjunction with financial transaction processing system 305 and the account transfer as may be provided by account transfer system 307. It should be noted that the illustrated system is intended to be exemplary only and other systems and configurations may be used in other embodiments.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. This description of the exemplary embodiments is intended to be read in connection with the figures of the accompanying drawing, which are to be considered part of the entire written description.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for transferring legal account ownership for a stored value card, said method comprising:
issuing a stored value card in a name of a first person authorized to use said stored value card and associated with an account and a legal account holder including an initial legal account holder being a second person;
comparing account data to each of a plurality of triggering criteria;
when a predetermined number of said plurality of triggering criteria is satisfied by said account data, transferring said legal account holder from said second person to said first person.

2. The method as in claim 1, wherein said issuing includes opening said account associated with an issuer and wherein said transferring maintains said account with said issuer.

3. The method as in claim 1, wherein said issuing includes opening said account for said stored value card with an issuer within a system, and
wherein said transferring automatically creates a further account with said issuer in said system.

4. The method as in claim 1, further comprising providing initial values of said account data to a system, said account data changing at least one of in time and as said stored value card is used, and
wherein said comparing is done by said system, and
further comprising said system determining if each of said triggering criteria is satisfied by said account data and said system causing said transferring.

5. The method as in claim 1, wherein said comparing is done substantially continuously or daily.

6. The method as in claim 1, wherein said plurality of triggering criteria include age of said first person, account age, date, average account balance, and amount of cash transactions of said account over a time period.

7. The method as in claim 1, wherein said stored value card includes a magnetic-stripe that stores information associated with said account therein.

8. The method as in claim 1, wherein prior to said transferring, only said first person is authorized to use said stored value card for purchases, payments and cash withdrawals and only said legal account holder is able to add funds to said stored value card.

9. The method as in claim 1, further comprising said legal account holder adding funds to said stored value card and wherein said funds are added to said card by at least one of a credit card account, an off-line debit or check card account, an intra-bank transfer and a paper check.

10. The method as in claim 1, wherein funds may be added to said stored value card only by said legal account holder and one or more further givers designated by said legal account holder.

11. The method as in claim 1, wherein, prior to said transferring, said first person is authorized to activate said stored value card, select a PIN for said stored value card, make purchases, make ATM withdrawals, make payments, make interlink purchases with cash back, suspend said account and dispute a transaction, but cannot add value to said stored value card, and
wherein said legal account holder is exclusively authorized to identify one or more givers that can add funds to said stored value card, and close said account.

12. The method as in claim 1, wherein said issuing includes said legal account holder agreeing to and being exclusively bound by terms and conditions of said account and further comprising, prior to said transferring, said initial legal account holder establishing parameters for use of said stored value card by said first person.

13. The method as in claim 1, wherein said issuing includes said stored value card having said cardholder's name thereon and, after said transferring, said stored value card is associated with said account and said legal account holder being said first person.

14. The method as in claim 1, wherein said transferring comprises notifying said initial legal account holder and receiving authorization from said initial legal account holder.

15. The method as in claim 1, wherein said first person is a teenager and said second person is one of said teenager's parent and a guardian, and wherein said transferring occurs upon receipt of authorization from said second person.

16. A system for issuing a stored value card affiliated with an issuer, a cardholder and a legal account holder, said system comprising:
a financial processing system that creates one account associated with said stored value card and issues said stored value card in a name of said cardholder and associated with a legal account holder, wherein an initial legal account holder is different than said cardholder and said cardholder is authorized to use said stored value card,
a card generating system that marks said stored value card with said cardholder's name;
a financial transaction processing system that compares account data of said stored value card to each of a plurality of triggering criteria and determines when a predetermined number of said plurality of triggering criteria is satisfied by said account data; and
a system that transfers said legal account holder from said initial legal account holder to said cardholder if said predetermined number of said plurality of triggering criteria is satisfied by said account data.

17. The system as in claim 16, wherein said plurality of triggering criteria include age of said cardholder, age of said account, date, average account balance, and amount of cash transactions of said account over a time period.

18. The system as in claim 16, wherein said financial processing system that creates one account provides initial values of said account data to said system, said account data changes at least one of in time and as said stored value card is used, and said financial transaction processing system that compares account data compares account data of said stored value card to each of said plurality of triggering criteria on a substantially continuous or daily basis.

19. The system as in claim 16, wherein said financial processing system provides for said stored value card to be used exclusively by said cardholder and for funding to be added to said stored value card by said legal account holder.

20. The system as in claim 19, further comprising said financial processing system providing for a further giver designated by said legal account holder, to add value to said stored value card.
